(19) United States
(12) Patent Application Publication
(10) Pub. No.: US 2009/0131123 A1
(43) Pub. Date: May 21, 2009

(54) REDUCED POWER CONSUMPTION IN SOFTWARE RADIOS

(75) Inventors: Edmund Coersmeier, Bochum (DE); Yuhuan Xu, Bochum (DE); Martin Kosakowski, Bochum (DE); Marc Hoffmann, Essen (DE)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 12/280,752

(22) PCT Filed: Mar. 17, 2006
(86) PCT No.: PCT/US06/09700

§ 371 Date: Aug. 26, 2008

(51) Int. Cl. H04M 1/00; H04B 1/10

(52) U.S. Cl. 455/574; 455/226.1

(57) ABSTRACT

Provided are apparatuses and methods for reducing processor load or power consumption during channel estimation in a receiver. For example, a receiver may monitor a transmission channel and determine if a change in channel parameters or characteristics has occurred. If a change is detected, the receiver may update filter coefficients associated with channel estimation. If a change is not detected, the filter coefficients may be maintained such that no change or updated is made to the filter coefficients.

### FIELD OF THE INVENTION

The invention relates generally to mobile telecommunications networks. More specifically, the invention relates to reduced power consumption during channel estimation of transmission channels.

### BACKGROUND OF THE INVENTION

Software (SW) radios have gained importance in wireless communication in which transmitter modulation is generated or defined by data processing computer components or a processor/multi-processor field, and the receiver uses a computer to recover signals by applying appropriate algorithms. To select the desired modulation type, the proper programs must be run by microcomputers or data processing devices that control the transmitter and receiver or by directly executing the algorithms. A typical software radio uses software for the modulation and demodulation of radio signals by performance of large amounts of signal processing. Hence, a software radio may expend large amounts of energy (i.e., power) to receive and transmit signals by the execution of software.

Channel estimation in software radios may be accomplished with Wiener or any other interpolation filters, e.g. LMMSE. The filter coefficients calculated for the interpolation filter are typically based on actual or estimated channel conditions. Calculation of coefficients in an interpolation filter consumes processing power. This increased power demand can be costly. Channel estimation and channel and source decoding require a high level of processing power as compared to other activities such a synchronization, demodulation, etc.

Wiener coefficient calculation and interpolation is performed in a time direction and/or in a frequency direction. For example, Wiener coefficient interpolation often requires 17% in the time direction of the overall time direction Wiener filter process and requires 15% in the frequency direction of the overall frequency direction Wiener filter process. In addition, in the time-direction, other related calculations for coefficient update require 6% in the time direction which includes calculation for time-correlation (1%) and Wiener coefficient calculation via Levinson (1%). In the frequency direction, other related calculations require 78% such as Wiener coefficient calculation via Levinson (49%) and calculation for frequency-correlation (29%).

The Wiener filter can estimate channel transfer function via coefficient calculation, however, the Wiener coefficient calculation requires a large overall power consumption. Thus, a system and method is needed for providing coefficient calculation such as Wiener coefficient calculation in estimation of channel transfer function while reducing the amount of power in determining or estimating transfer functions while maintaining performance.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example, a method of reducing power consumption in a receiver is provided comprising detecting a change in a transmission channel parameter and updating a filter coefficient of a filter for estimating the transmission channel if a change in the transmission channel parameter is detected. Otherwise, if a change in the transmission channel parameter is not detected, then the filter coefficient is maintained.

In another example, a receiver is provided including a channel monitor for monitoring a transmission channel, a filter module for estimating the transmission channel based on a filter coefficient and an updater for updating the filter coefficient if a change in the transmission channel is detected.

In yet another example, a computer-readable medium is provided for causing a receiver to detect a change in a transmission channel parameter and updating a filter coefficient for a filter in estimating the transmission channel based on detecting the change in the transmission channel parameter.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a time variant channel and Additive White Gaussian Noise (AWGN) source in which one or more illustrative embodiments may be implemented.

FIG. 2 illustrates an example of a delay power spectrum in accordance with an aspect of one embodiment.

FIG. 3 illustrates an example of an exponentially decaying delay power spectrum in accordance with an aspect of one embodiment.

FIG. 4 illustrates an example of spaced-frequency correlation of constant delay power spectrum in accordance with an aspect of one embodiment.

FIG. 5 illustrates an example of a spaced-frequency correlation of exponential decaying delay power spectrum in accordance with an aspect of one embodiment.

FIG. 6 illustrates an example of a Gaussian Doppler power spectrum in accordance with an aspect of one embodiment.

FIG. 7 illustrates an example of a corresponding spaced-time correlation in accordance with an aspect of one embodiment.

FIG. 8 illustrates an example of an overview of the relationship between system functions in accordance with an aspect of an embodiment.

FIG. 9 illustrates an example of an irregular temporal pattern of detection of changes in transmission channel parameters and a corresponding irregular temporal pattern of updating of filter coefficients in accordance with an aspect of one embodiment.

FIG. 10 illustrates an example of an estimated impulse response in accordance with an aspect of one embodiment.

FIG. 11 illustrates measurements on a signal reception in accordance with an aspect of one embodiment.

FIG. 12 illustrates a suitable digital broadcast receiver in which one or more illustrative embodiments of the invention may be implemented.

FIG. 13 is a partial block diagram illustrating an example of a receiver in transmission channel estimation in accordance with an aspect of one embodiment.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

Software radios have gained increasing preference over hardware implementation. Often hardware radios are costly to design and manufacture but may provide high speed implementation of different algorithms as compared to software. In a software radio, the number of operations may be limited per unit time. Such limitations may depend on the processor architecture, clock frequencies, bus and memory bandwidth, or any other factors including algorithm complexity and/or radio software architecture.

In one example, a filter, such as a multi-dimensional interpolation filter (e.g., a two dimensional Wiener filter), may be used for run time calculations of coefficients in either a software or hardware implemented radio. The interpolation filter may determine channel estimation for a transmission channel of a signal. The channel estimation may be performed by the interpolation filter through mathematical operations and coefficient calculation. Such calculations may include, for example, matrix-vector operations, trigonometric functions, etc. in the receiver. Such calculations consume processor time, thereby causing high power consumption. In one example of the present invention, the complexity of the interpolation filter is reduced without significant performance loss. In this example, a novel scheme is provided to optimize filter coefficient calculations, for example, in a Wiener filter, thereby conserving power and reducing processor usage.

Channel estimation may be performed for wireless transmission channels. Such transmission channels may include, for example, digital transmission systems such as Orthogonal Frequency Division Multiplex (OFDM) implemented in Digital Radio Mondiale (DRM). Signals are transmitted over transmission channels to a receiver which may estimate properties or characteristics of the transmission channel. Interpolation filters (e.g., Wiener filters) may be employed in channel estimation as described herein. Operation of the filters in channel estimation may include the application of filter coefficients which may need to be updated over time depending on the transmission channel.

For example, as the transmission channel varies over time and/or frequency, the filter coefficients associated with the interpolation filter may be updated to correspond to the variances in the transmission channel. Because power may be consumed in the process of updating the filter coefficients, in one example, a method and system is provided for reducing the power consumed in interpolation filter operation in channel estimation. For example, computational effort is reduced in an example of the present invention to reduce power consumption.

In one example, updating of filter coefficients may be performed when a change is detected in transmission channel parameters. For example, a change in transmission channel parameters may indicate a change in properties or characteristics of the transmission channel. When a change in a transmission channel parameter is detected, filter coefficients may be updated. When a change in a transmission channel parameter is not detected, then filter coefficients are not updated (i.e., the filter coefficients may be maintained without changes). Hence, in this example, changes or updates to filter coefficients associated with interpolation filters for channel estimation (e.g., Wiener filters) may be made when changes are detected in transmission channel parameters but not when changes are not detected in the transmission channel parameters. When changes are not detected in the transmission channel parameters, then no action is taken with regard to updating filter coefficients and the filter coefficients may be maintained at current values. In this way, power consumption and processor load may be reduced because the filter coefficients are not updated or changed when no changes are detected in the transmission channel parameters.

In another example, filter coefficients may be updated when a change is detected in a channel parameter at or above a predetermined threshold. For example, a maximum delay spread may be determined corresponding to the transmission channel. In this example, the power of a signal may be measured such that the power of a channel impulse response may be calculated to determine a maximum delay spread. The delay power spectrum may further be determined given the maximum delay spread. When the maximum delay spread changes over a predetermined threshold, filter coefficients may be correspondingly updated.

In another example, a Doppler spread may be determined based on a Doppler shift. For example, a spaced time correlation function may be obtained by correlating with a first draft channel estimate. The first draft channel estimate may be achieved, for example, by a zero forcing algorithm. The Doppler shift and Doppler spread may be determined based on the spaced time correlation function. In one example, when the Doppler spread changes over a predetermined threshold, filter coefficients may be updated.

In yet another example, filter coefficients may be updated when a change in signal-to-noise ratio (SNR) over a predetermined threshold is detected. For example, the SNR may be measured by comparing a received QAM constellation diagram with ideal ones. The SNR may thus be determined and if a change in the SNR is detected that exceeds a predetermined threshold, the filter coefficients may be updated.

### Interpolation Filter Coefficients

In an example, a channel model may be time variant. The channel model may include Nₚ paths where each path is described by function hₙ(t) as follows:

$${h}_{n} ( τ , t ) = {\sum }_{n = 1}^{{N}_{p}} {h}_{n} ( t ) δ ( τ - {τ}_{n} ) \qquad ( 1 )$$

The time delay for the n^{th} path may be given by τₙ. A received signal r(t) may be described by the following:

r(t)=s(t)*h(τ,t)+n(t) (2)

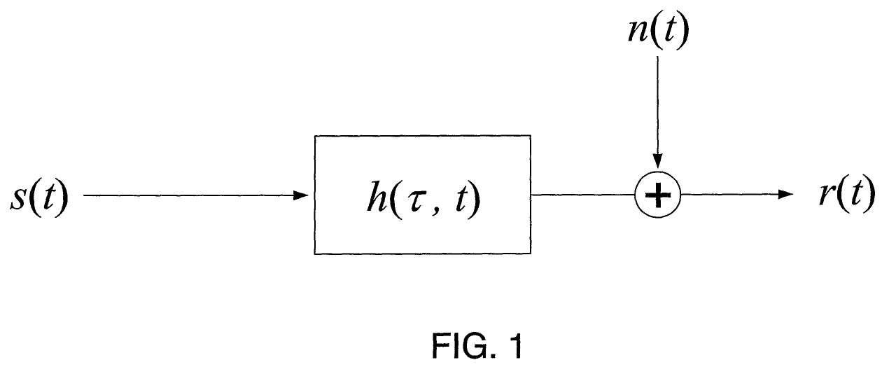

FIG. 1 illustrates a time variant channel and Additive White Gaussian Noise (AWGN) source in one example. As FIG. 1 and equation (2) illustrate, the received signal r(t) may contain the convolution of the transmit signal s(t) with the channel impulse response h(τ, t) and may also include additive white Gaussian noise n(t). The statistical properties of h(τ, t) may be based on Wide Sense Stationary Uncorrelated Scattering (WSSUS) principle in which WSSUS-based auto-correlation of the channel impulse response can provide the multipath delay profile describing the average power output of the channel as a function of the time delay τ.

The multipath delay profile may be about equal to a delay power spectrum if Δt=0 and provides the base to define the root mean square (rms) delay spread. The delay power spectrum may be introduced as follows:

φ(τ,Δt)=E{h(τ,t)h*(τ,t−Δt)} (3)

The multipath delay profile may provide the base to define the root mean square (rms) delay spread. The average excess delay may be introduced as follows:

$$\overline{τ} = \frac{1}{{σ}_{h}^{2}} {\int }_{0}^{max} τ \cdot {φ}_{h} ( τ ) d τ \qquad ( 4 )$$

In this example, the maximum excess delay may be defined as τₘₐₓ and equation (4) may be normalized to a channel's average power as follows:

$${σ}_{h}^{2} = {\int }_{0}^{max} {φ}_{h} ( τ ) d τ \qquad ( 5 )$$

The rms delay spread Δτ may be defined as follows:

$$Δτ = \sqrt{\frac{1}{{σ}_{h}^{2}} {τ}^{2} \cdot {φ}_{h} ( τ ) d τ - {\overline{τ}}^{2}} \qquad ( 6 )$$

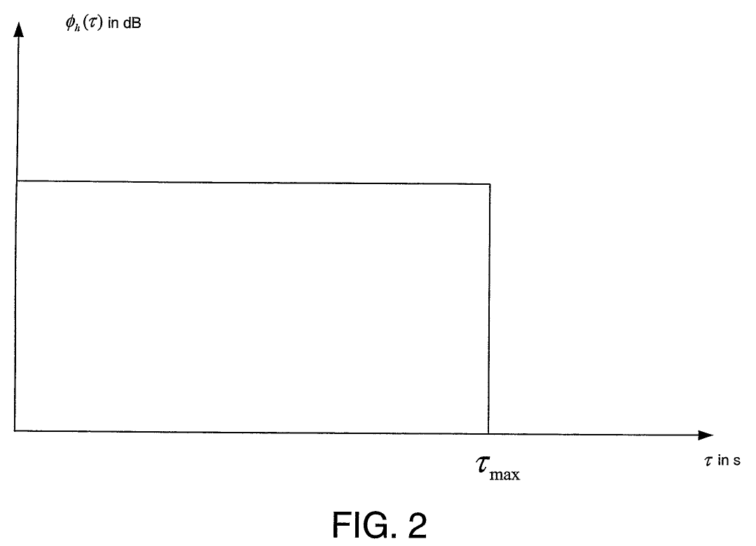

FIG. 2 illustrates an example of a delay power spectrum. In this example, of a delay power spectrum is a constant delay power spectrum that may be expressed as follows:

$${φ}_{h} ( τ ) = \frac{{σ}_{h}^{2}}{{τ}_{max}} \cdot \{ \begin{matrix}1 , & for 0 \leq τ \leq {τ}_{max} \\ 0 , & otherwise\end{matrix} \} \qquad ( 7 )$$

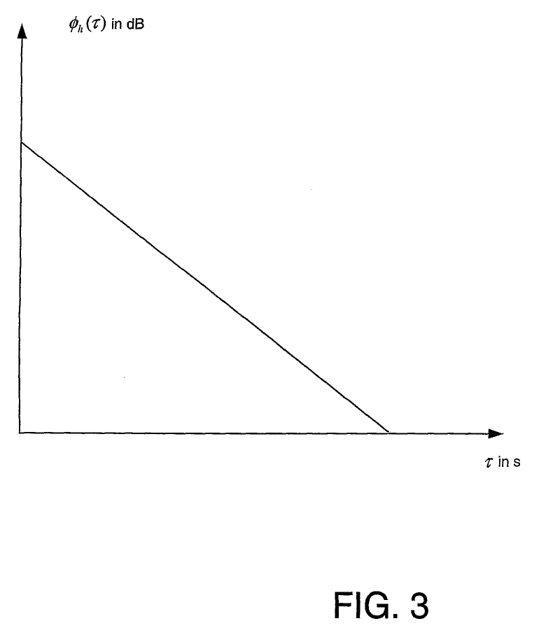

FIG. 3 illustrates an example of an exponentially decaying delay power spectrum. The exponentially decaying delay power spectrum may be provided as follows:

$${φ}_{h} ( τ ) = \frac{{σ}_{h}^{2}}{{τ}_{0}} \cdot \{ \begin{matrix}{e}^{\frac{τ}{{τ}_{0}}} , & for τ \geq 0 \\ 0 , & otherwise\end{matrix} \} \qquad ( 8 )$$

Where τₒ may define a decaying constant for the delay power spectrum. The Fourier Transformed (FT) time varying channel impulse response h(τ,t) may equal the time varying channel transfer function H(f, t) as follows:

$$H ( f , t ) = {\int }_{- ∞}^{+ ∞} h ( τ , t ) {e}^{- j2π f τ} d τ \qquad ( 9 )$$

The spaced-frequency, spaced-time correlation function may be based on the expectation of correlating equation (9):

φₕ(Δf,Δt)=E{H(f,t)·H*(f−Δf,t−Δt)} (10)

Based on the delay power spectrum (equation (3)) and the channel transfer function (equation (9)), the spaced-frequency, spaced-time correlation function may be further expressed as follows:

$${φ}_{h} ( Δ f , Δ t ) = {\int }_{- ∞}^{+ ∞} {φ}_{h} ( τ , Δ t ) {e}^{- j2 π f τ} d τ \qquad ( 11 )$$

Further, the spaced-frequency correlation function can be obtained when Δt=0 (i.e., the FT of the delay power spectrum) as follows:

$${φ}_{h} ( Δ f ) = {\int }_{- ∞}^{+ ∞} {φ}_{h} ( τ ) {e}^{- j2 π f τ} d τ \qquad ( 12 )$$

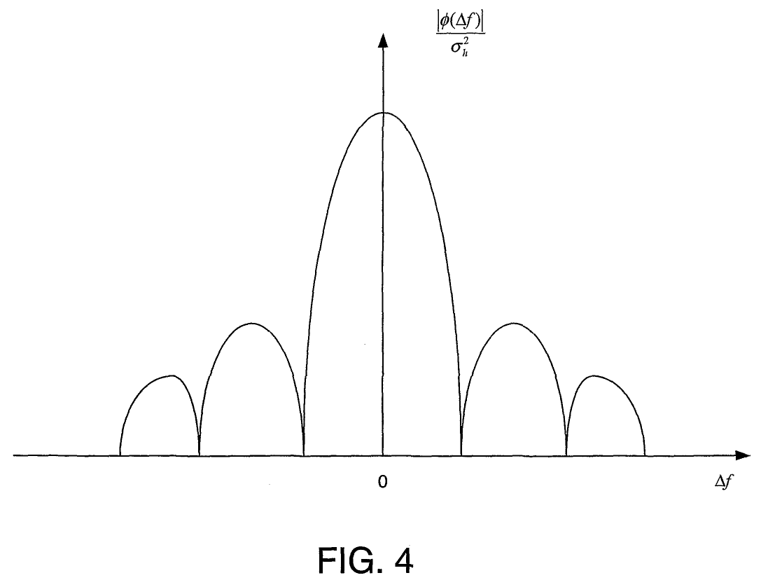

As one example of the spaced-frequency correlation function φₕ(Δf), FIG. 4 illustrates an example of spaced-frequency correlation of constant delay power spectrum in which the correlation based on a constant delay power spectrum may be expressed as follows:

φₕ(Δf)=σₕ²·si(πτₘₐₓΔf)·e^{-jπτ}^{ₘₐₓ}^{Δf} (13)

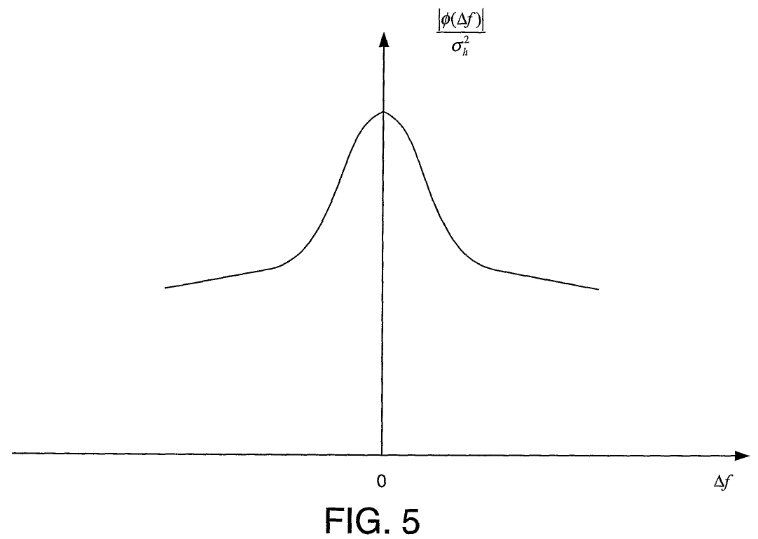

FIG. 5 illustrates an example of a spaced-frequency correlation of exponential decaying delay power spectrum. In this example, the spaced-frequency correlation based on the exponentially decaying delay power spectrum may equal

$${φ}_{h} ( Δ f ) = \frac{{σ}_{h}^{2}}{1 + j2 {πτ}_{0} Δ f} \qquad ( 14 )$$

Also, from equation (10), spaced-time correlation function φₕ(Δt)=φₕ(0,Δt) can be obtained, for example, when Δf=0. In this example, the FT of the Doppler power spectrum S_{H}(f_{D}) may be expressed as follows:

$${S}_{H} ( {f}_{D} ) = {\int }_{- ∞}^{+ ∞} {φ}_{h} ( Δ t ) {e}^{- j2π {f}_{D} Δ t} d Δ t \qquad ( 15 )$$

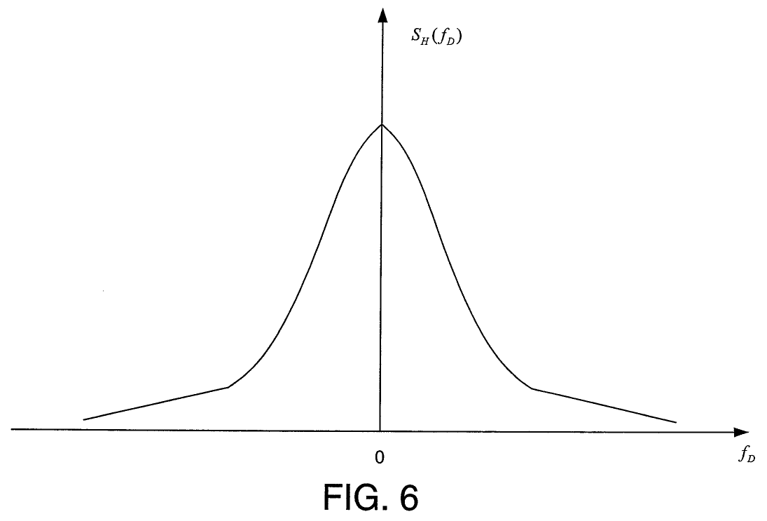

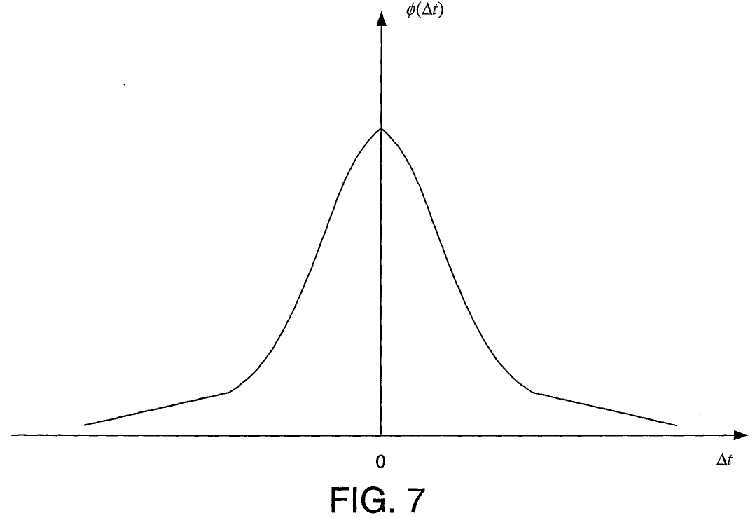

FIG. 6 illustrates an example of a Gaussian Doppler power spectrum. FIG. 7 illustrates an example of a corresponding spaced-time correlation. For example, the spaced-frequency, spaced-time correlation function can be expressed as a product of two independent correlation functions as follows:

φₕ(Δf,Δt)=φₕ(Δf)·φₕ(Δt) (16)

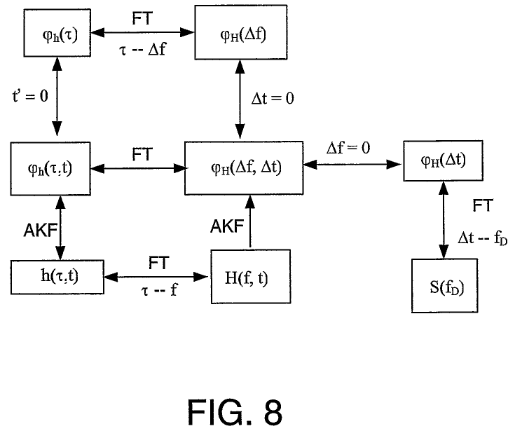

FIG. 8 illustrates an example of an overview of the relationship between system functions as described herein.

In another example, the introduction of the channel model and related correlation functions are provided such that Wiener filter coefficient calculation may be performed. Channel statistics may be employed to calculate the Wiener filter coefficients. A pilot-symbol-aided channel estimation in frequency domain may be taken into account. A received signal R_{k,l} at a discrete frequency k and discrete time instance l may be based on the channel transfer function H_{k,l} and the AWGN N_{k,l} as follows:

R_{k,l}=S_{k,l}H_{k,l}+N_{k,l} (17)

Channel estimation may be performed in a variety of ways. In one example, the channel estimation may be performed by estimating the channel transfer function Ĥ_{k′,l}′ at the pilot positions P_{k′,l}′ as follows:

$${\hat{H}}_{{k}^{′} , {l}^{′}} = \frac{{R}_{{k}^{′} , {l}^{′}}}{{P}_{{k}^{′} , {l}^{′}}} = {H}_{{k}^{′} , {l}^{′}} + \frac{{N}_{{k}^{′} , {l}^{′}}}{{P}_{{k}^{′} , {l}^{′}}} \qquad ( 18 )$$

Where k′ and l′ describe the positions of the noisy pilots in frequency and time direction, respectively. Thus, the estimates Ĥ_{k′,l}′ may be noisy as well. The channel estimation may further include introducing interpolation to calculate the channel transfer function Ĥ_{k,l} at the remaining positions.

In Wiener filtering, the estimation of Ĥ_{k,l} at position (k, l) can be calculated by the channel estimates Ĥ_{k,l} by channel estimates Ĥ_{k′,l}′ at pilot positions (k′, l′) via a filter interpolation as follows:

$${\hat{H}}_{k , l} = {\sum }_{\{ {k}^{′} , {l}^{′} \} ∈ P} {w}_{{k}^{′} , {l}^{′}}^{k , l} {\hat{H}}_{{k}^{′} , {l}^{′}} \qquad ( 19 )$$

Where the variable P in the above equation describes a set of pilots, which may be used for interpolation. Superscript indices (k,l) may indicate that different interpolation filter coefficients may be needed for different frequencies k and time instances l.

Interpolation filter optimization, of which Wiener filter optimization is an example, may also be accomplished by optimizing the coefficients w_{k′,l′}^{k,l} to minimize the Mean-Square-Error (MSE). The MSE may be calculated as follows:

J(w_{k′,l′}^{k,l})=E{|H_{k,l}−Ĥ_{k,l}|²} (20)

The Minimum-Mean-Square-Error (MMSE) estimator may satisfy the orthogonality condition by the following:

E{(H_{k,l}−Ĥ_{k,l})·Ĥ*_{k′,l′}}=0 (21)

The filter coefficients (e.g., Wiener filter coefficients) w_{k′,l′}^{k,l} may be calculated when the estimation error H_{k,l}−Ĥ_{k,l} is orthogonal to the pilot-based values Ĥ*_{k′,l′}. Combining equation (19) and (21) results in the Wiener-Hopf equation as follows:

$$E \{ {H}_{k , l} \cdot {\hat{H}}_{{k}^{′} , {l}^{′}}^{*} \} = {\sum }_{\{ {k}^{′} , {l}^{′} \} ∈ P} {w}_{{k}^{′} , {l}^{′}}^{k , l} \cdot E \{ {\hat{H}}_{{k}^{′} , {l}^{′}} \cdot {\hat{H}}_{{k}^{′} , {l}^{′}}^{*} \} \qquad ( 22 )$$

Cross-correlation E{H_{k,l}·Ĥ*_{k′,l′}} describes the correlation properties between the ideal transfer function H_{k,l} and the pilot-based estimation Ĥ*_{k′,l′} and may be equal to the spaced-frequency, spaced-time correlation function E{H_{k,l}·H*_{k′,l′}} from equation 10. The noise disappears because of the independence from the channel process as well as the missing mean value.

r_{HĤ}_{ₚ}(k−k′,l−l′)=E{H_{k,l}·Ĥ*_{k′,l′}}=E{H_{k,l}·H*_{k′,l′}}=r_{HH}_{ₚ} (23)

Auto-correlation E{Ĥ_{k″,l″}·Ĥ*_{k′,l′}} describes the correlation properties at the pilot positions Ĥ_{k″,l″} and can be expressed based on equation (10) as follows.

r_{Ĥ}_{ₚ}_{Ĥ}_{ₚ}(k″−k′,l″−l′)=E{H_{k″,l″}·H*_{k′,l′}}+σₙ²·δ(k″−k′,l″−l′)=r_{H}_{ₚ}_{H}_{ₚ}+σₙ²·δ(k″−k′,l″−l′) (24)

Where σₙ² represents the power of the additive white noise process. Combining equations (22), (23), and (24) results in the following matrix-vector notation:

r̅_{HĤ}_{ₚ}^{T}(k,l)= w̅^{T}(k,l) R̅_{Ĥ}_{ₚ}_{Ĥ}_{ₚ}(k,l) (25)

With auto-correlation matrix:

R̅_{ĤPĤP}(k,l)= R̅_{HPHP}(k,l)+σₙ²·Ī (26)

And cross-correlation vector

r̅_{HĤ}_{ₚ}(k,l)= r̅_{HH}_{ₚ}(k,l) (27)

The final Wiener coefficient vector may be given as:

w̅^{T}(k,l)= r̅_{HH}_{ₚ}^{T}(k,l)·[ R̅_{HPHP}(k,l)+σₙ²·Ī]⁻¹ (28)

The estimation of the transfer function may be done via pilot-based interpolation as follows:

Ĥ_{k,l}= w̅^{T}(k,l) ĥ̅(k′,l′) (29)

In another example, two-dimensional filtering can be replaced by two one-dimensional filters. Equation (16) demonstrates that the correlation function r_{HH}(Δk,Δl) of the channel transfer function H(f,t) can be written as the product in frequency and time direction.

r_{HH}(Δk,Δl)=r_{f}(Δk)·rₜ(Δl) (30)

r_{f}(Δk) is the correlation in frequency direction as a consequence of the delay spread. rₜ(Δl) is the correlation in the time direction which may be a consequence of the Doppler spread. For a constant delay power spectrum, the spaced-frequency correlation function r_{f}(Δk) can be the FT of the delay power spectrum.

r_{f}(Δk)=si(τₘₐₓΔk)·e^{-jπ(τ}^{ₘₐₓ}^{+τ}^{_{max off}}^{)Δk} (31)

where τₘₐₓ is the maximum excess delay and τ_{max off} is the impulse offset in case of non-ideal synchronization. Wiener filter in the frequency direction w̅_{f}^{T}(k,l) may be expressed by the following:

w̅_{f}^{T}(k,l)= r̅_{HH}_{_{p,f}}^{T}(k,l)·[ R̅_{H}_{ₚ}_{H}_{_{p,f}}(k,l)+σₙ²·Ī]⁻¹ (32)

In another example, the spaced-time correlation function rₜ(Δl) may be calculated as an FT of the Doppler power spectrum as described in equation 15.

rₜ(Δl)=e^{-2(Nσis d}^{πT}^{ₛ}^{Δl)}^{²} (33)

Dₛₚ=2σ_{d} may be used to describe the Doppler spread. Wiener filter in the time direction w̅ₜ^{T}(k,l) may be determined as follows:

w̅ₜ^{T}(k,l)= r̅_{HH}_{_{p,t}}^{T}(k,l)·[ R̅_{H}_{ₚ}_{H}_{_{p,t}}(k,l)+σₙ²·Ī]⁻¹ (34)

Final interpolation in the time direction may be given by the following:

Ĥ_{\tilde{k},\tilde{l}}= w̅ₜ^{T}(k,l) ĥ̅(k′,l′) (35)

Interpolation in the frequency direction may be given by the following:

Ĥ_{k,l}= w̅_{f}^{T}(k,l) ĥ̅(\tilde{k},\tilde{l}) (36)

### Reduction of Power Consumption

Coefficient calculation via correlation function and Wiener-based interpolation may result in intensive software radio processor load. For example, coefficient calculation and storing may need up to 85% or higher of the processor load. However, interpolation may need only about 15% of the processor load. In this example, the coefficient calculation processor load may be reduced without significant Wiener filter interpolation performance loss.

Receiver implementations may update filter coefficients during run time [symbol] . One example of a filter coefficient that may be updated during run time includes an interpolation filter coefficient in the frequency direction such as, for example, equation 32. Another example of a filter coefficient may include, for example, a filter coefficient in the time direction such as, e.g., equation 34. For example, changes or updates in filter coefficients of an interpolation filter may be necessary depending on the status of the corresponding transmission channel. The changes or updates to the filter coefficients of an interpolation filter at the receiver may be performed at pre-defined, equidistant, or static time instances to ensure that the filter coefficients are up-to-date. However, performing such regular updates may be costly in terms of power consumption. For example, performing a change or update to filter coefficients may involve extensive mathematical calculations such that a large amount of power or energy is necessary to perform a change or update repeatedly. Power or energy may be wasted if such changes or updates are performed when such changes or updates are not necessary. For example, if the transmission channel status has not substantially changed since the last update or change in the filter coefficients, a change or update in filter coefficients might not be necessary. Performing a change or update (i.e., performing the mathematical operations) would result in wasted power or energy.

In one example, power consumption at the receiver may be reduced by performing filter coefficient updates and changes at times when such updates and changes are needed or desired. For example, a change in status of the corresponding transmission channel may be detected which may result in a corresponding change or update of filter coefficients. Similarly, when no change in status of the corresponding transmission channel is detected, an update or change to the filter coefficients is not performed, thus conserving power and energy. By performing filter coefficient changes or updates only at times when needed or desired, such as when a change in status in the corresponding transmission channel is detected, the number of updates or changes to the filter coefficients per unit time may be decreased thereby reducing the amount of mathematical calculations performed by the filter. This may result in decreased power consumption.

Reducing the power consumption by changing or updating filter coefficients when a change in status in the corresponding transmission channel is detected may result in an increase in the update interval length. This may occur, for example, when there is no substantial change detected in the status of the corresponding transmission channel for a period of time. Hence, to provide for up-to-date filter coefficients, the filter coefficients may be updated if the channel conditions have been changed and require new optimized filter coefficients. Filter coefficients are updated only if channel conditions have been changed such as when a change in transmission channel parameters is detected.

Hence, in this example, updating of filter coefficients, such as the Wiener filter coefficients as one example, is performed when necessary as based on detected changes in a transmission channel parameter. In this way, updating of filter coefficients may be performed at irregular time intervals rather than regular, periodic intervals. For example, if changes in transmission channel parameters are detected at irregular time intervals such that the changes are detected over a broad spectrum of frequencies, then updating of filter coefficients may likewise be performed at a corresponding irregular time interval. For example, OFDM may use channels spaced at constant intervals with different transmission characteristics resulting in different channel transfer functions (e.g., equation 1). In this example, the temporal pattern of updating of filter coefficients may correspond to the temporal pattern of detecting of changes in transmission channel parameters.

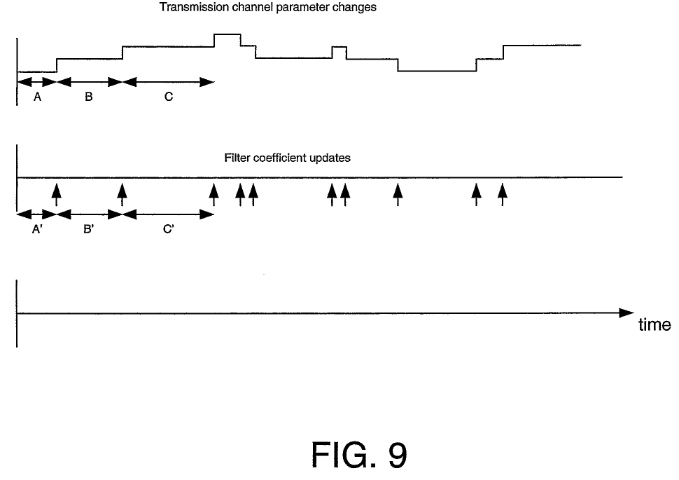

FIG. 9 illustrates an example of an irregular temporal pattern of detection of changes in transmission channel parameters and a corresponding irregular temporal pattern of updating of filter coefficients. In this example, changes in transmission channel parameters are detected at an irregular frequency. As FIG. 9 illustrates, the time interval between subsequent changes in transmission channel parameters may vary (i.e., might not be constant). For example, the time interval between the first detected change in transmission channel parameters is designated in FIG. 9 as A. This time interval may have a different length from another time interval between two other instances of detection of changes in transmission channel parameters. FIG. 9 illustrates, for example, the next time interval between the second and third instances of detection of changes in transmission channel parameters designated as B is different from time interval A (i.e., time interval B is illustrated as longer than time interval A in this example). Likewise, time interval C between the third and fourth instances of detection of changes in transmission channel parameters illustrated in FIG. 9 is also different in length from time interval A or time interval B, in this example. Hence, in this example, the frequency of detection of changes in transmission channel parameters may vary which may result in a varying temporal pattern of detection of the changes in the transmission channel parameters.

Also illustrated in the example of FIG. 9 is updating of filter coefficients. The second curve illustrated in FIG. 9 illustrates an example of a varying temporal pattern of updating of filter coefficients for channel estimation. The vertically oriented arrows in FIG. 9 indicate time instances at which filter coefficients are changed or updated. In this example, the updating of filter coefficients (indicated by the vertically oriented arrows) may be performed when a change in transmission channel parameters is detected. Because the detection of changes in transmission channel parameters occurs at irregular time intervals as described above, the corresponding updating of filter coefficients also occurs at corresponding irregular time intervals. As seen in the second curve of FIG. 9, when a change in transmission channel parameters is detected, filter coefficients are updated (as indicated by the vertically oriented arrows). When a change in transmission channel parameters is not detected, then the filter coefficients are not updated but are maintained at current values. The time interval between subsequent filter coefficient updates may vary as illustrated. For example, the time interval between the first and second illustrated filter coefficient updates is designated as A′ in this example. The time interval between the second and third illustrated filter coefficient updates is designated as B′ in this example. Time interval A′ and time interval B′ are different (i.e., time interval B′ is longer than time interval A′). Likewise time interval C′ (the time interval between the third and fourth illustrated filter coefficient updates) is different from time interval A′ or time interval B′. Hence, in this example, updating of the filter coefficients is performed at irregular time intervals and is based on the detection of changes in transmission channel parameters.

Alternatively, changes in transmission channel parameters may be detected at regular time intervals (i.e., at an approximately constant frequency). In this case, updating of filter coefficients may be performed at a corresponding regular time interval based on the detection of transmission channel parameters.

In an example of channel estimation in OFDM (Orthogonal Frequency Division Multiplex) radios, Wiener filters with Wiener filter coefficients may be used in a mathematical implementation of channel estimation. The filter coefficients calculated and used by the filter may be based on actual or estimated channel conditions. The channel transfer function estimation may need processing power in performing the filter coefficient calculations. In this example of the invention, power consumption in power processing associated with filter coefficient calculation may be reduced in software radios and hardware implementations.

In one example, the number of filter coefficient calculations or updates is adjusted dynamically to correspond to transmission channel property changes. For example, the interval of time between coefficient updates may be increased, decreased or maintained depending on a determined need for a coefficient update. In one example, a channel property rating is determined for indicating a need for a filter coefficient update. In this example, when a channel monitor indicates that filter coefficients may be out-of-date, the update may be performed. Conversely, if there are no major changes in the channel parameters, then the filter coefficients may be maintained in their present state such that there is no update of the filter coefficients. Hence, power consumption may be reduced when filter coefficients are not updated.

The filter coefficient calculation may be performed in a time direction based on an estimated Doppler spread or may be performed in a frequency direction where the filter coefficient calculation may be based on a parameter associated with the filter coefficients. For example, the estimation performed in a frequency direction may be based on a frequency range of OFDM carriers such that different coefficients may be calculated for different OFDM sub-carriers. Transmission channels may cover a wide frequency range and channel properties associated with the transmission channels and the corresponding filter coefficients may be different. Thus, channel estimation in a frequency direction may provide for calculation of coefficients. In addition, pilots may not be available for all sub-carriers within one OFDM symbol. Thus, an OFDM symbol may be interpolated internally in a frequency direction for any missing sub-carriers. In addition, interpolation in a time direction may also be accomplished per sub-carrier for each OFDM symbol by including at least two or more OFDM symbols in time direction. Application of the process to OFDM is merely one example as the process may be applied to any transmission mode.

In another example, the different OFDM carriers may have different propagation properties or may be described by different channel transfer functions. A change in any of the parameters or combination of parameters associated with the filter (e.g., Wiener filter) may indicate the need for an update of the filter coefficients. For example, a change in one of the estimated impulse offset τ_{max off} and maximum impulse delay τₘₐₓ may indicate that a change in the filter coefficients may be made. Also, in one example illustrated in equation (28), the filter coefficients may be related to the channel's Additive White Gaussian Noise (AWGN). In addition, noise may be stable during the measurement procedure.

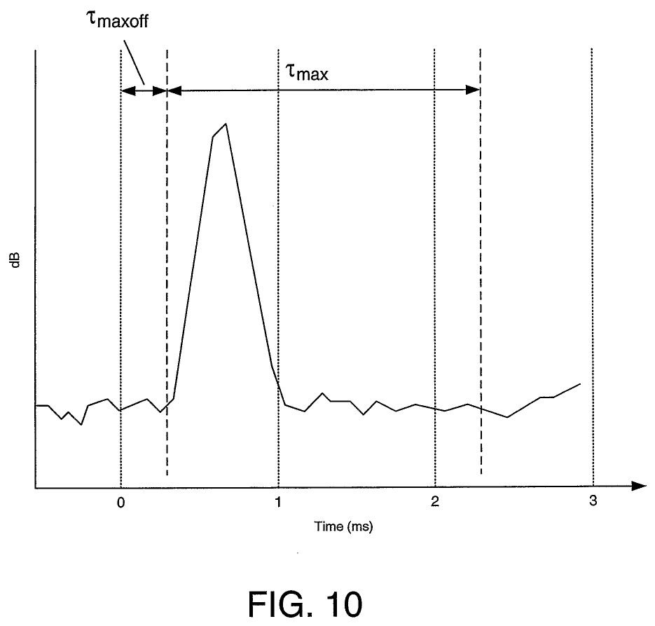

FIG. 10 illustrates an example of an estimated impulse response. In this example, an impulse measurement in a Digital Radio Mondiale (DRM) channel is illustrated with a maximum offset and a maximum delay. Changes in filter coefficients may be made based on the maximum offset and maximum delay as illustrated in FIG. 10.

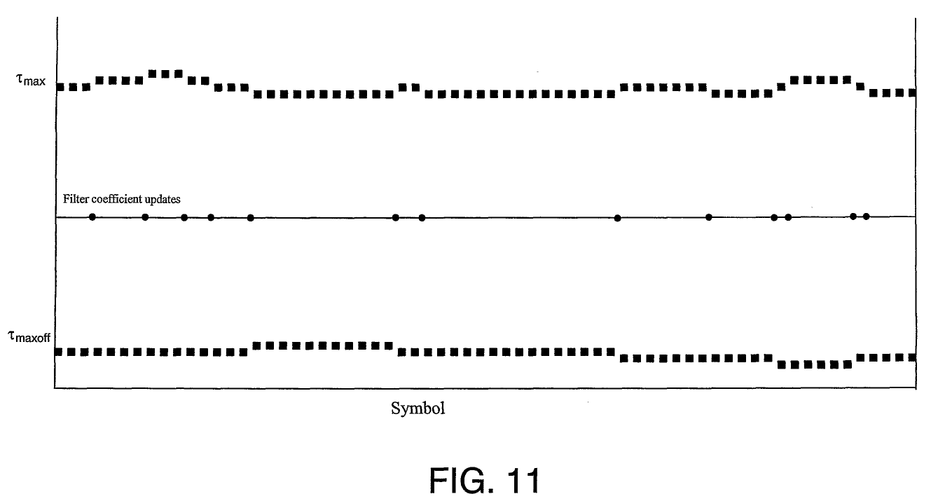

FIG. 11 illustrates an example of detecting transmission parameter changes such as the maximum offset and maximum delay illustrated in FIG. 10 and updating filter coefficients based on the detecting. In this example, a receiver may monitor the transmission channel and changes in one or both of the estimated impulse offset τ_{max off} and maximum impulse delay τₘₐₓ are detected. In this example, a parameter corresponding to a delay spread may be estimated for channel estimation. For example, the delay spread parameter may include τₘₐₓ or τ_{max off} which may be estimated continuously to identify whether the corresponding values have changed.

If no changes are determined for the filter coefficients, then the filter coefficients are not re-calculated, in this example. If a change is identified for the estimated impulse offset τ_{max off} or the maximum impulse delay τₘₐₓ, then a filter coefficient update may be performed. In another example, a parameter corresponding to Doppler spread or Signal-to-Noise Ratio (SNR) of the channel may be estimated for channel estimation.

FIG. 11 illustrates measurements on a signal reception in a Digital Radio Mondiale (DRM) environment. In this example, changes for the channel parameters (e.g., the estimated impulse offset τ_{max off} and maximum impulse delay τₘₐₓ) are identified during reception of several OFDM symbols. In the upper curve in FIG. 11, the maximum impulse delay τₘₐₓ is illustrated. The lower curve in FIG. 11 illustrates the estimated impulse offset τ_{max off}. Each of the parameters illustrated may change independently of each other and may also remain stable over several OFDM symbols. As FIG. 10 illustrates, dynamic channel observation may be performed to obtain an impulse measurement over time. During certain periods, each of the estimated impulse offset τ_{max off} and the maximum impulse delay τₘₐₓ may remain unchanged. During these periods, an update to the channel parameters or the filter coefficients is not performed. At certain times as illustrated in the example of FIG. 11, either the estimated impulse offset τ_{max off}, the maximum impulse delay τₘₐₓ, or both may change. At these times, a change or update to the filter coefficients may be desired. The middle curve in FIG. 11 illustrates updating of filter coefficients which may be based on a change of the estimated impulse offset τ_{max off} and/or maximum impulse delay τₘₐₓ.

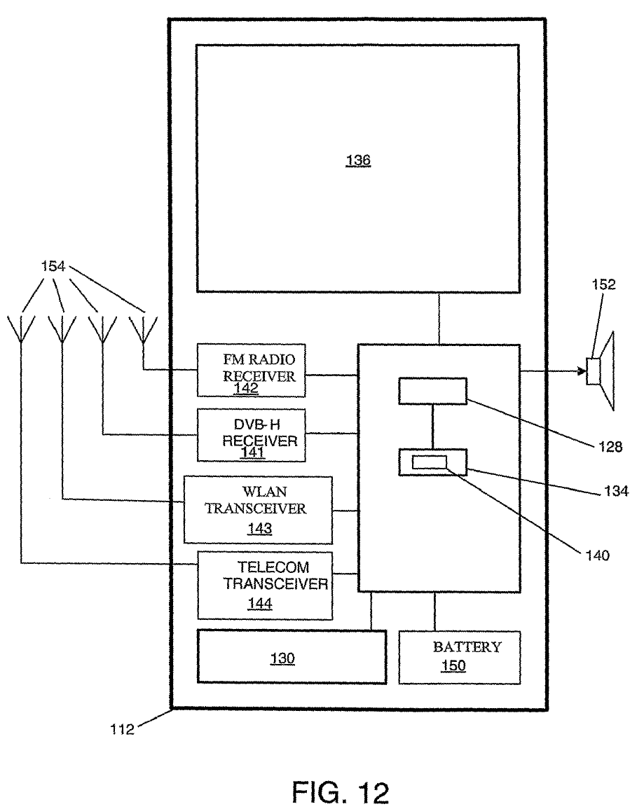

As shown in FIG. 12, mobile device 112 may include processor/homogeneous or heterogeneous multi-processor field 128 connected to user interface 130, memory 134 and/or other storage, and display 136. Mobile device 112 may also include battery 150, speaker 152 and antennas 154. User interface 130 may further include a keypad, touch screen, voice interface, one or more arrow keys, joy-stick, data glove, mouse, roller ball, touch screen, voice interface, or the like.

Computer executable instructions and data used by processor/homogeneous or heterogeneous multi-processor field 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions as described herein. Alternatively, some or all of mobile device 112 computer executable instructions may be embodied in hardware or firmware (not shown).

Mobile device 112 may be configured to receive, decode and process transmissions based on the Digital Video Broadcast (DVB) standard, such as DVB-H or DVB-MHP, through a specific DVB-H receiver 141. Additionally, receiver device 112 may also be configured to receive, decode and process transmissions through FM/AM Radio receiver 142, WLAN transceiver 143, and telecommunications transceiver 144. In one aspect of the invention, mobile device 112 may receive messages via radio data system (RDS).

In another example, antenna sampling may be performed such that digital RF and baseband may be processed in the SW radio. For example, a signal may be received and sampled via the antenna 154 and converted into a digital domain such that all signal processing may be performed via the SW radio. Further analog signal processing may be subsequently performed.

In an example of the DVB standard, one DVB 10 Mbit/s transmission may have 200, 50 kbit/s audio program channels or 50, 200 kbit/s video (TV) program channels. A mobile device may be configured to receive, decode, and process transmissions based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting—Terrestrial), DRM (Digital Radio Mondiale), DAB (Digital Audio Broadcasting), DMB (Digital Multimedia Broadcasting) or DIRECTV. Additionally, the digital transmission may be time sliced, such as in DVB-H technology. Time-slicing may reduce the average power consumption of a mobile terminal and may enable smooth and seamless handover. Time-slicing consists of sending data in bursts using a higher instantaneous bit rate as compared to the bit rate required if the data were transmitted using a traditional streaming mechanism. In this case, the mobile device may have one or more buffer memories for storing the decoded time sliced transmission before presentation.

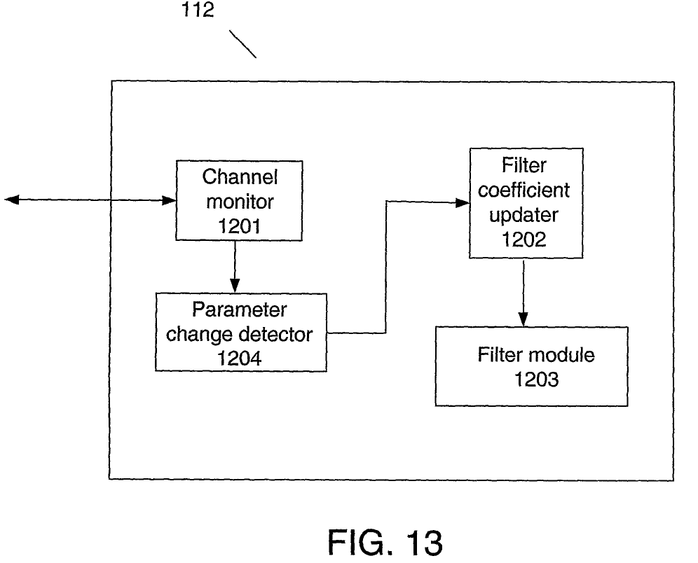

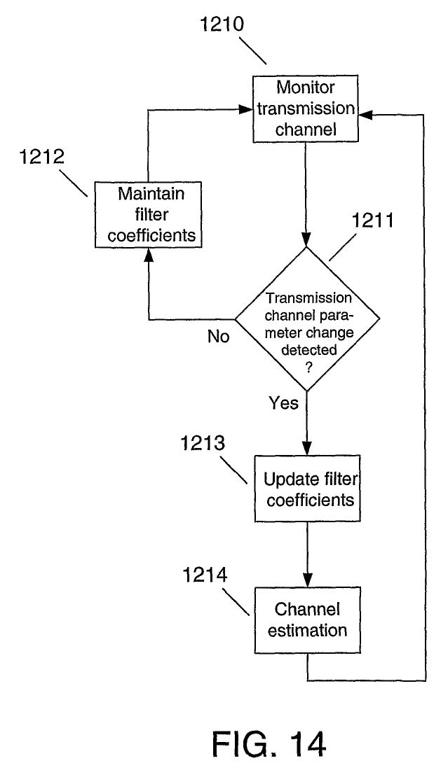

FIG. 13 is a partial block diagram illustrating an example of a receiver 112 in transmission channel estimation. FIG. 14 is a flowchart illustrating an example of a method for updating filter coefficients at a receiver 112 for channel estimation. In this example, the receiver 112 may contain a channel monitor 1201 for monitoring a transmission channel (STEP 1210 in FIG. 14). The channel monitor 1201 may monitor the status of the transmission channel which may be based on at least one transmission channel parameter. For example, the channel monitor 1201 may monitor a transmission channel parameter such as an impulse delay or impulse offset for a change in any of the monitored transmission channel parameters (STEP 1210, FIG. 14). Additional examples of transmission channel parameters that may be monitored or changed include but are not limited to Doppler spread parameters or Signal-to-Noise-Ratio parameters of the channel.

The receiver 112 may further contain a parameter change detector 1204 as illustrated in FIG. 13. The parameter change detector 1204 may be operatively connected to the channel monitor 1201. Alternatively, the parameter change detector 1204 and the channel monitor 1201 may be incorporated together into one component. The parameter change detector 1204 may detect a change in a transmission channel parameter based on the monitoring of the transmission channel by the channel monitor 1201 (STEP 1211, FIG. 14). When the parameter change detector detects a change in a channel transmission parameter such as a change in an impulse delay or impulse offset (“YES” branch of STEP 1211), the parameter change detector 1204 may identify channel properties that have changed and may provide a new channel property value to a coefficient calculation. The parameter change detector 1204 may further forward a signal or indicator to the filter coefficient updater 1202 in the receiver 1205. The filter coefficient updater 1202 may receive the signal or indicator from the parameter change detector 1204 and, responsive to the signal or indicator, the filter coefficient updater 1202 may update filter coefficients for the filter module 1203 (STEP 1213, FIG. 14). The filter module 1203, for example a Wiener filter, may perform calculations to determine channel estimation (STEP 1214, FIG. 14). The channel estimation calculations may be based on values of the filter coefficients. The filter coefficient updater 1202 may update the filter coefficients (STEP 1213, FIG. 14) to reflect the status of the transmission channel which may be based on the transmission parameter change detected by the parameter change detector 1204 (STEP 1211, FIG. 14). Hence, the filter module 1203, based on the updated filter coefficients, may efficiently perform channel estimation based on detected changes in a transmission channel parameter. If a change of a transmission channel parameter is not detected at the parameter change detector 1204 (the “NO” branch of STEP 1211, FIG. 14), then the filter coefficient updater 1202 does not update the filter coefficients in this example. The filter coefficients are maintained at their present values (STEP 1212, FIG. 14) if no change is detected in a transmission channel parameter. Hence, the filter module 1203 maintains the current values of the filter coefficients (STEP 1212), monitoring of the transmission channel may continue (STEP 1210) and power consumption in the receiver 1205 is conserved.

Thus, filter coefficients may be updated corresponding to changes in channel conditions. The changes in channel conditions may be indicated by changes in corresponding transmission channel parameters such as, for example, an impulse offset and/or an impulse delay. Thus, the number of updates of filter coefficients per unit time may be decreased, processor load may be reduced and/or power consumption may be reduced.

The embodiments herein include any feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques.

We claim:

1. A method of reducing power consumption in a receiver comprising:
detecting a change in a channel parameter associated with transmission channel properties of a transmission channel for reception of a signal;
updating a filter coefficient corresponding to a filter if a change in the channel parameter is detected, otherwise, maintaining the filter coefficient.

2. The method of claim 1 wherein the filter is an interpolation filter for estimating the transmission channel.

3. The method of claim 2 wherein the filter coefficient is based on additive white Gaussian noise of the transmission channel.

4. The method of claim 2 wherein the filter coefficient is based on one of a delay spread, Doppler Spread and Signal-to-Noise Ratio (SNR).

5. The method of claim 4 wherein the filter coefficient is based on the delay spread, the delay spread comprising one of a maximum excess delay and an impulse offset.

6. The method of claim 1 wherein the detecting step comprises monitoring the transmission channel and continuously estimating the channel parameter.

7. The method of claim 1 wherein updating the filter coefficient comprises updating a filter coefficient at a first time and a second time subsequent to the first time based on the detecting.

8. The method of claim 7 wherein the first time and second time are separated by a variable time interval.

9. The method of claim 1 wherein detecting the change in a channel parameter comprises detecting a change in a channel parameter at a plurality of times at a variable frequency.

10. The method of claim 1 wherein the filter estimates the transmission channel.

11. The method of claim 1 wherein detecting the change in a channel parameter comprises detecting a change in a channel parameter at a first time and detecting a change in a channel parameter at a second time, the first time and second time being separated by a variable length of time.

12. The method of claim 11 wherein updating a filter coefficient comprises updating the filter coefficient at approximately the first time and the second time.

13. The method of claim 1 wherein detecting the change in a channel parameter comprises detecting a change in a channel parameter at a first time;
detecting a change in a channel parameter at a second time subsequent to the first time and separated from the first time by a first time interval; and
detecting a change in a channel parameter at a third time subsequent to the second time and separated from the second time by a second time interval,
wherein the first time interval and the second time interval are different.

14. The method of claim 13 wherein updating a filter coefficient comprises updating the filter coefficient at approximately the first time, the second time and the third time.

15. A receiver for estimating a transmission channel comprising:
a channel monitor for monitoring a transmission channel status based on a channel transmission parameter;
a filter module for estimating the transmission channel based on at least one filter coefficient; and
a filter coefficient updater for updating the at least one filter coefficient if a change in the channel transmission parameter is detected.

16. The receiver of claim 15 wherein the filter module comprises an interpolation filter.

17. The receiver of claim 15 wherein the filter coefficient is based on additive white Gaussian noise of the transmission channel.

18. The receiver of claim 15 wherein the filter coefficient is based on one of a delay spread, Doppler Spread and Signal-to-Noise Ratio (SNR).

19. The receiver of claim 18 wherein the filter coefficient is based on the delay spread, the delay spread comprising one of a maximum excess delay and an impulse offset.

20. The receiver of claim 15 wherein the channel monitor further monitors the transmission channel and continuously estimates the channel transmission parameter.

21. The receiver of claim 15 further comprising a detector operatively connected to the channel monitor for detecting a change in a transmission channel parameter.

22. A computer-readable medium comprising computer-readable instructions for performing the steps of:
detecting a change in a channel parameter associated with transmission channel properties of a transmission channel for transmission of a signal;
updating a filter coefficient corresponding to a filter for estimating the transmission channel if a change in the channel parameter is detected, otherwise, maintaining the filter coefficient.

23. A mobile device comprising:
a channel monitor for monitoring a transmission channel status based on a channel transmission parameter;
a filter module comprising at least one filter coefficient; and
a filter coefficient updater for updating the at least one filter coefficient if a change in the channel transmission parameter is detected.

24. The mobile device of claim 23 comprising a mobile phone.

25. The mobile device of claim 23 further comprising a receiver for receiving input in an Orthogonal Frequency Division Multiplex (OFDM) system.

26. The mobile device of claim 25 wherein the OFDM is implemented in DRM (digital radio mondiale).

27. The mobile device of claim 23 wherein the channel transmission parameter is one of a delay spread parameter, a Doppler spread parameter and a Signal-to-Noise Ratio (SNR) parameter.

28. The mobile device of claim 27 wherein the channel transmission parameter comprises a delay spread parameter including at least one of an estimated impulse offset and a maximum impulse delay.
